(19) United States
(12) Patent Application Publication
(10) Pub. No.: US 2016/0214332 A1
(43) Pub. Date: Jul. 28, 2016

(54) Method of Making Of Carbon Fiber Composite Sheet

(71) Applicant: Jing Zhao, Winchester, MA (US)

(72) Inventor: Jing Zhao, Winchester, MA (US)

(21) Appl. No.: 15/078,292

(22) Filed: Mar. 23, 2016

Related U.S. Application Data
(63) Continuation-in-part of application No. 14/271,424, filed on May 6, 2014.
(60) Provisional application No. 61/916,752, filed on Dec. 16, 2013.

(51) Int. Cl. B29C 70/46; B29C 33/40; B29C 33/38

(52) U.S. Cl. CPC B29C 70/46; B29C 33/3842; B29C 33/405; B29K 2063/00

(57) ABSTRACT

A method for making a carbon-fiber composite sheet and spring using a two-piece molding device is disclosed. The two piece mold includes a hard mold made of wood or metal and a soft mold insert made of rubber or silicon material. Carbon-fiber composite sheep is shaped by being pressed between the hard mold and soft mold insert, and cured at higher than 60° C.

### CROSS-REFERENCE TO RELATED APPLICATIONS

This application is a continuation-in-part of the U.S. Non-Provisional application Ser. No. 14/271,424 filed on May 6, 2014, titled “Carbon Fiber Composite Springs and Method of Making Thereof,” the content of which are hereby incorporated by reference in their entirety and for all purposes.

### BACKGROUND OF THE INVENTION

Spring or spring like structures have been traditionally made using metals. There are applications that require springs of lightweight, such as in aerospace and automobile for fuel efficiency, cushions in helmets and shoes for better protection. Lightweight springs, if can be realized, will offer unprecedented benefits for these applications. The recent developments in carbon fiber composites have created a unique route for fabrication lightweight springs. However, carbon fiber composites have challenges for spring construction: 1) less flexible; 2) brittle; and 3) high anisotropic. The known spring configurations are intrinsically unsuited for carbon fiber composite springs, resulting in springs of smaller deformation and lower spring constant, consequently smaller capacity to load.

Therefore, what is needed for a new spring configuration that fully utilizes carbon fiber's unique properties to provide large elastic deformation and large transfer force in a compact form as well as using minimum amounts of materials as well as low cost manufacturing for wide range of applications.

### SUMMARY

This invention concerns a method for making a carbon fiber composite sheet spring which comprises a bow shaped shell of elastically deformable material made of carbon fibers laying substantially unidirectional along the curvature from one end to the other having certain thickness to length ratio. In addition, they are often provided with an upper surface adjacent to the curvature center and a lower surfaces adjacent to the two ends which are often bended through which the loads are applied. The inventive carbon fiber sheet spring configuration fully takes advantage of carbon fiber's unique properties to provide elastic flexibility and higher spring constant, as well as ability to provide large transfer forces in a compact form. Economical manufacturing methods of making thereof are disclosed herein, allowing suitable product applications such as in shoes, helmets and seats.

In one aspect of the embodiment, the arch shaped carbon fiber band-stripes are fabricated by using two-piece molding process in which one mold is made of hard and rigid material, a composite material replica of the sample or machined from drawings using wood or metal, and the other is a soft mold made of silicon or other polymer rubber materials by pouring into the hard mold before it is solidified. To fabricate a complex carbon fiber composite sheet spring, pre-preg or carbon fibers soaked with resin are first put into the hard mold and then are pressed by the soft silicon mold between the hard mold and the soft silicon matching mold, and followed by curing at an elevated temperature. Because of the large thermal expansion of silicon materials, the expansion of the soft mold during heating will hold carbon fiber tightly onto the hard molded contour and simultaneously squeeze out excess resin, eliminating the need for vacuum bagging or high pressure autoclaving.

In another embodiment, carbon-fiber filaments of the pre-preg or carbon fibers soaked with resin are interlaced or interweaved, and after soft-mold insert is placed onto said carbon-fiber filaments to form a thin configuration, another layer of different fabric material, such as a sheet of cotton cloth seeping with epoxy resin is placed onto the sheet, this process is continued for the required number of times, then the soft-mold insert is placed into the hard mold to form a tight sandwich with the fabric layers in between the hard mold and the soft-mold insert, finally the sandwich set is heated at a temperature above 60° C. and is then cooled to room temperature to obtain sheet spring form.

In one aspect of an embodiment, the carbon fiber composite sheet is made of multiple layers of fabric materials; each layer comprises different fabric materials bonded together with adhesives.

In another aspect of an embodiment, carbon fiber composite sheet is made of multi-layers of mesh-like carbon fiber layers interlaced with other fabric material sheets formed together with epoxy resin or other adhesives.

The described carbon fiber sheet designs offer many vanguard advantages. First, to take advantage of carbon fibers' extremely large tensile strength, the spring configuration intrinsically provides exceptional counter forces to large loads in an extremely thin compact format. Because of the thin sheet feature, the spring configuration allows for maximum free deformation movement, thus a deformation capability of over 80% of its virgin height, resulting in large kinetic energy absorption and storage. Further, being of the carbon fiber material, sheet springs made thereof are much lighter than polymer foam cushions of similar thickness. Simultaneous shaping and carbon-fiber material molding reduces the cost in manufacturing, enabling carbon-fibers being used more widely in making consumer products.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1A shows a perspective view of an example carbon fiber spring having an arch shaped band-stripe spring configuration, made of carbon fiber composite, in its original position in accordance with this application.

FIG. 1B shows the cushion of FIG. 1A in compressed position in accordance with this application.

FIG. 2A shows a perspective view of an example arched-cross spring configuration, made of carbon fiber composite, in its original position in accordance with this application.

FIG. 2B shows the spring of FIG. 2A in compressed position in accordance with this application.

FIG. 3A shows a perspective view of an example ellipsed ring spring configuration, made of carbon fiber composite, in its original position in accordance with this application.

FIG. 3B shows the spring of FIG. 3A in compressed position in accordance with this application.

FIG. 4 shows a perspective view of an example brace spring configuration with half-folded ends, made of carbon fiber composite, in its original position in accordance with this application.

FIG. 5 shows a perspective view of an example complex brace spring configuration with connected half-folded ends, made of carbon fiber composite, in its original position in accordance with this application.

FIG. 6 shows a perspective view of an example complex spring configuration with inward-bended ends and connected top portion, made of carbon fiber composite, in its original position in accordance with this application.

FIG. 7 shows a transparent perspective view of a two-piece mold made of hard and soft materials respectively, in demonstrating the method of making, in accordance with this application.

FIG. 8 shows a comparison of deformation strength under various weight forces between a shoe sole having the spring of FIG. 1A, a conventional rubber shoe foam, and a metal spring in accordance with this application.

FIG. 9 shows an expanded perspective view of an example hybrid carbon fiber composite sheet configuration, made of hybrid layers of carbon fiber and fabric layers in accordance with this application.

FIG. 10 shows a perspective view of an example hybrid carbon fiber composite fiber having a hybrid thread configuration made of hybrid layer of carbon fiber and fabric layers in accordance with this application.

### DETAILED DESCRIPTION OF THE INVENTION

The numerous innovative teachings of the present application will be described with particular reference to presently preferred embodiments (by way of example, and not of limitation). The present application describes several embodiments, and none of the statements below should be taken as limiting the claims generally. For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help the understanding of embodiments of the invention. The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition. Although the term “bounciness” or resiliently is utilized other equivalent terms may also be used to describe the resistance to deformation of carbon fiber spring. It should also be noted that the term “spring” as utilized herein is generic and encompasses various configurations and designs, such as those shown in the drawings or described in the specification. In this application, “sheet-band”, “curved like”, a “shell” or “bow shape” are used inter-exchangeable, to describe a curved band of carbon fiber or carbon fiber composite thin sheet that has a curvature shape.

The term “carbon fibers” and “carbon-fiber filaments” are used exchangeablly to mean generic carbon fibers in all sense that include graphite fibers as well as amorphous carbon fibers, where carbon atoms are bonded together in crystals that are more or less aligned parallel to the long axis of the fiber.

The term “carbon fiber composite (CFC)” refers to the composite material where strands of carbon fiber filaments are bound together with plastic polymer resin by heat, pressure or in a vacuum. Carbon fiber filament strands may be woven into a unidirectional, bidirectional mesh or screen like sheet. Carbon fiber strands may be interweaved with other material types of filaments and strands. The most commonly used resin is epoxy, but thermoplastic, polyurethane, vinyl ester, or polyester are also used. A carbon fiber composite can be directly shaped using a mold and placing the carbon fibers directly over the mold. Many carbon-fiber-reinforced polymers are created with a single layer of carbon fabric that is backed with fiberglass.

The term “fiber layer” herein is used interchangeably with “fabric layer” or “fabric layers”, meaning an entire section unit of fiber strands is mechanically more separable from another section unit of fiber strands while within one same section unit fiber strands are less easily separable.

The term “hybrid carbon fiber sheet” herein is used interchangeably with “hybrid flexible and elastic carbon fiber composite sheet” or “flexible and elastic carbon fiber fabrics,” meaning single or multiple carbon fiber layers are bounded with multiple layers of other flexible fabric materials via adhesives. This hybrid bounding may be done by molding, pressure or vacuum. The example other types of flexible fabrics include cotton, rayon, linen, synthetic clothes, fiber glass cloth, Kevlar cloth, wool, and leather.

The term “spring” or “springs” means a mechanical configuration that is deformable under effect of force and returns to original state after releasing of the force.

The term “sheet configuration” means a configuration where the width and length of the configuration is dramatically larger than the thickness domain.

The term “string or rod configuration” means the length of the configuration is dramatically larger than the width and height domain.

The term “mold” means the mechanical tool in this application that is made of rigid hard materials, in a hollow or matrix form for shaping a molten or plastic state material into a particular shape, mold is generally made of rigid hard material such as wood or rigid plastic materials.

The term “soft-mold insert” means the mechanical tool in this application that fits into a mold in shape, and is made of durable thermal insulating materials of high thermal expansion that expand in high temperature, for example, silicon polymer rubber materials.

The term “bound with” means that two fiber layers are made to stick/hold together by adhesives and pressure.

Carbon fiber composites have significant advantages for spring construction over conventional heat-treated steel. The modulus of elasticity (flexibility) of the carbon fiber composite is approximately the same as that of the steel. But the tensile strength of carbon fiber composite is about three times of that of steel. This means that the carbon fiber structure can withstand nearly three times as much the load as by a steel structure. In addition, the carbon fiber composites have significantly less weight per volume—only about 20% that of steel. Conversely, a carbon fiber composite spring having the same resistance as a steel spring may only weigh about 1/15 that of the steel spring. Carbon fiber springs are also of high chemical resistance and low thermal expansion, are more durable than steel springs and less concerns for rust.

However, carbon fiber spring performance is greatly influenced by the device configuration. Since carbon fiber is relatively soft to bend along the fiber strand, it does not generate sufficient tension to bounce in coil or leaf configuration to be used as a spring. The carbon fiber composite springs made of conventional leaf and coil configurations show poorer loading capacity than its metal counterparts. To utilize carbon fiber composite's unique high tensile strength along the fibers, special spring configurations have to be designed and tested that can achieve large force loading capability.

### Carbon Fiber Spring Design

Carbon fiber composite (CFC) is a very hard and brittle material. The challenge is to obtain elastic flexibility in order to us it for spring construction. Utilizing thin sheets consisting of carbon fibers sufficiently aligned in one direction in the form of bundled stow or weaved fabric, this application discloses a novel method in manufacturing a CFC spring with sufficient elasticity.

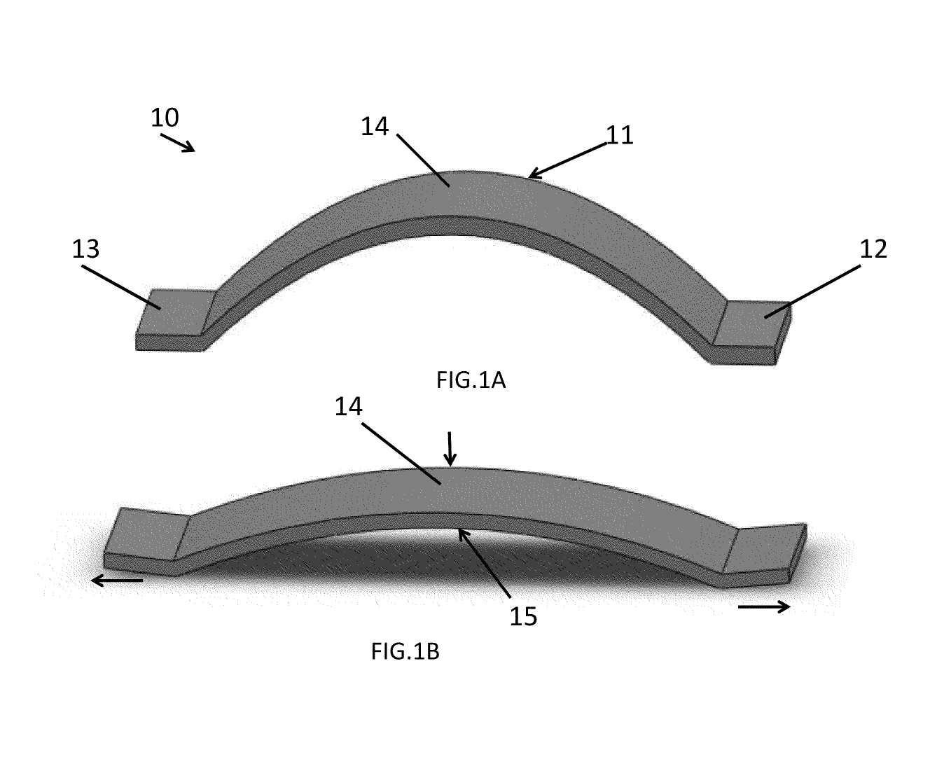

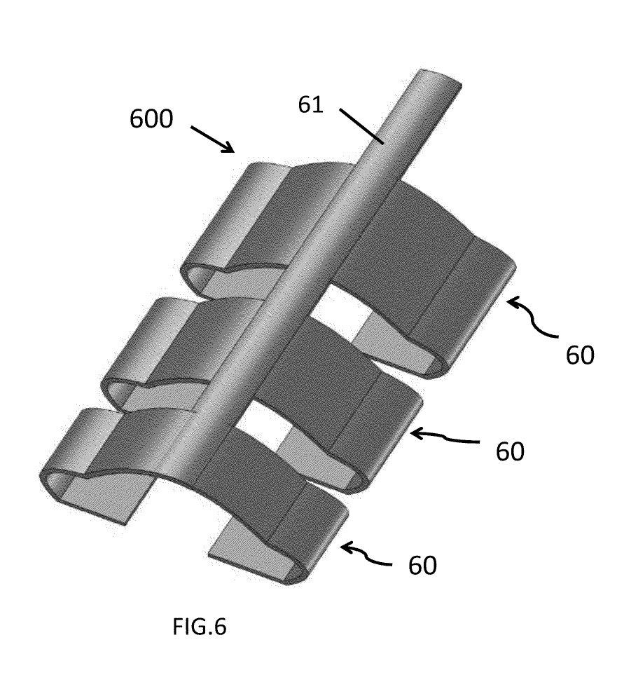

When the length to the thickness ratio above certain value, this carbon composite thin sheet becomes flexible along the axis of the fiber strands. The second challenge is to achieve large responsive force or large load. The inventive springs accomplish this by bow shape construction. FIG. 1A shows bow shaped CFC spring 10 made of a thin sheet carbon fiber composite pre-form into a shell or bow shape, having carbon fibers laying substantially along the curvature from end 12 to end 13. The spring 10 features at least one circular portion 14 connecting two peripheral feet portions 12 and 13 on both ends, which are bended for ease of applications. Alternatively, feet portions 12 and 12 can bend inwardly towards each other as shown in FIG. 6, having a dimensioned bending brace structure.

In reference to FIG. 1B, the carbon fiber spring 10 collapses its bow curvature to nearly flat position 15 upon the applying of a sufficiently large force on the curvature top 14. It absorbs the impact energy by building up internal tension along the curvature. Spring 10 restores the original bow shape when the force removed, creating a bounce effect in the process. During the spring action, the center of curvature 14 moves down vertically while spring 10 flattens out as the two feet 12 and 13 move horizontally.

The carbon fiber springs preferably have a length (from one end to another end of the curvature) to thickness ratio >10 to maintain flexibility and reliability.

This sheet-band spring configuration also provides a compact low profile which allows the springs be configured into tight space that is especially suited for shoe and helmet applications. The center and edges of the spring are preferably the mounting points.

In the alternative, carbon fiber composite spring 10 may be pre-configured in a relatively flat shape with a shallow curvature as shown in FIG. 1B to function as compression spring, in which the carbon fiber composite spring can be pushed to curve up upon application of a force as shown in FIG. 1A.

The bow shape also enables internal stress distributions along the curvature thus along the strenuous carbon fibers, greatly enhancing durability of the internal shearing force. This type of spring can also be utilized in key structural points to overcome carbon fiber composite brittleness with tendency of cracking, such as in chairs or other structures such as bicycles and airplane bodies.

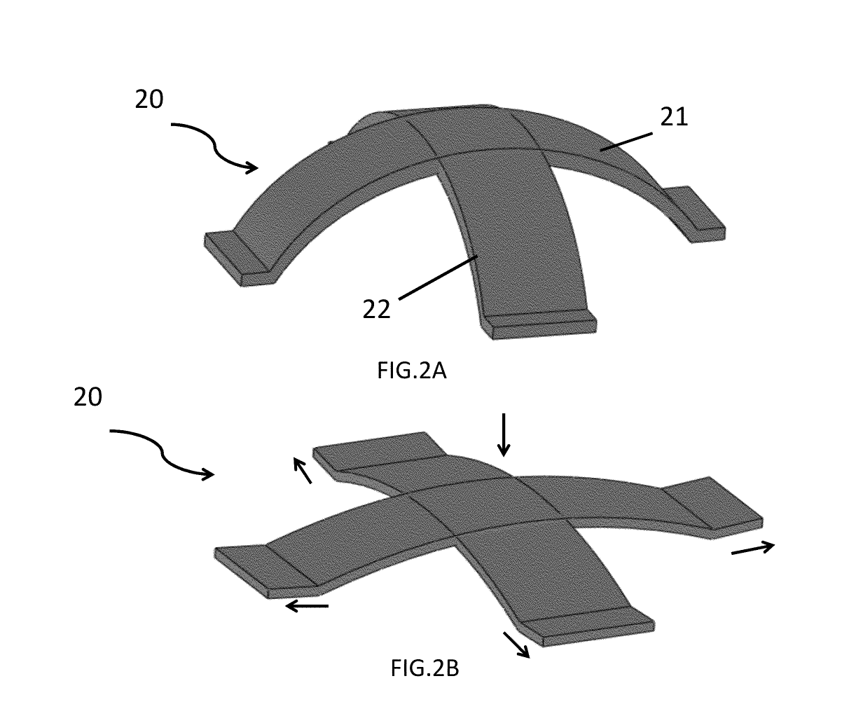

In reference to FIG. 2A and 2B, more than one CF bow springs can be assembled together into a single spring device to permit two dimensional spring motion as shown in spring 20. Spring portion 21 and 22 may be crossingly fixed with each. Moreover, the thickness along the spring sheet-band can be varied to specifically satisfy the various force loading conditions of a specific application in order to provide optimum dampening response.

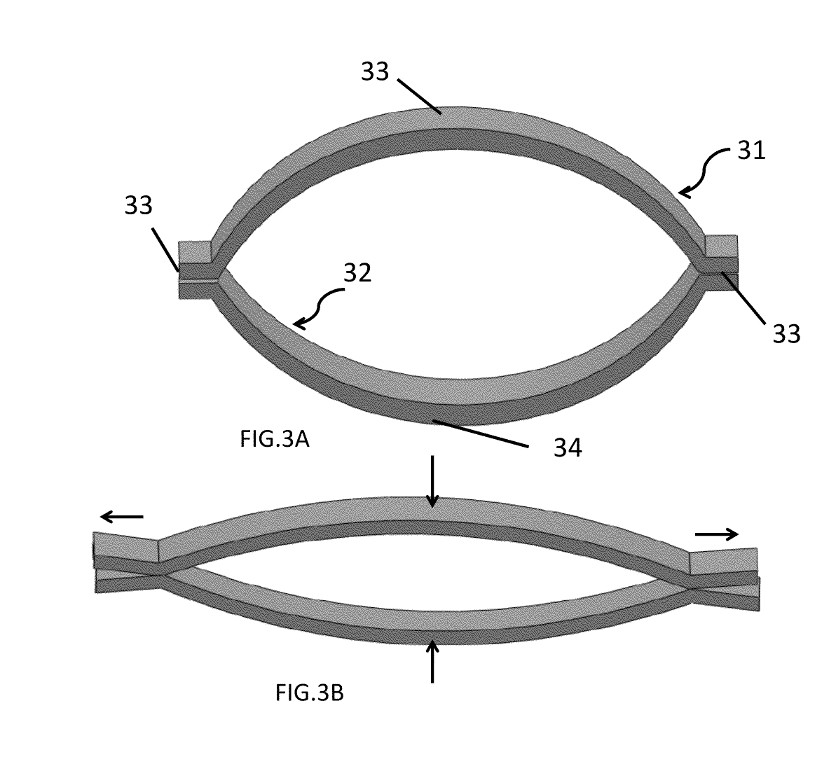

Multiple CFC bow springs can be stacked up to achieve added spring function. Two example embodiments are disclosed here. In reference to FIG. 3A and 3B, two bow CFC springs 31 and 32 are connected at their feet at 33 and 34 with their curvature in opposite directions to form a ring-like structure so that the spring moves in the vertical direction with twice of the displacement as that of the single spring. The surface portion 33 and 34 may serve as anchoring points to apply force and form anchor.

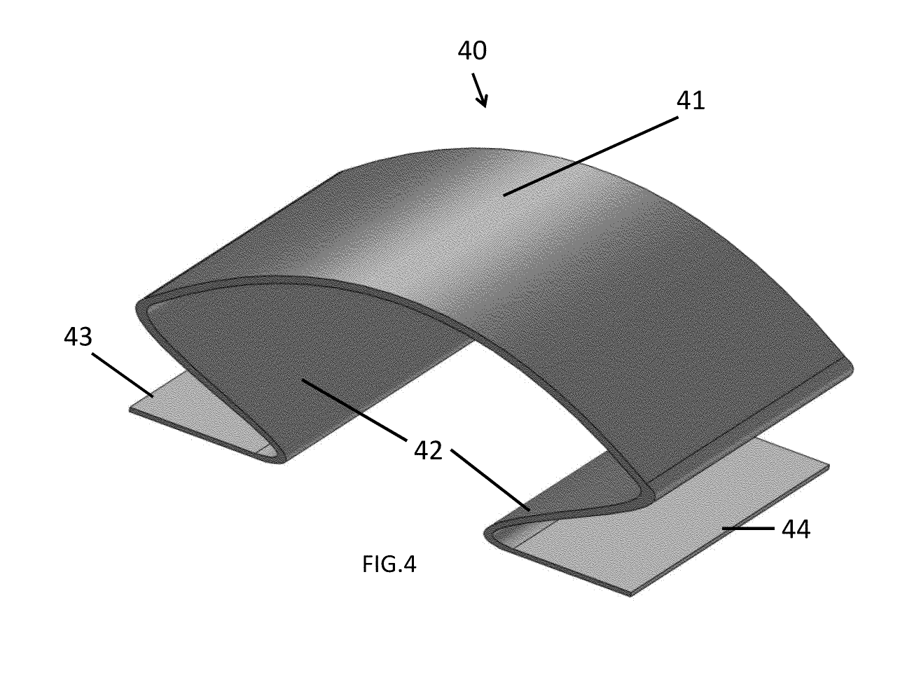

In reference to FIG. 4 an alternative bow spring design 40 is disclosed that essentially stacking bow curvature portion 41 and foot portions 43 and 44 together with respective stronger and curved support braces 42 having twice the displacement. The CFC spring 40 features compactness with two slightly curved sheet-band braces 42 arranged in opposite directions that are bridged with a sheet-band 41, along with two feet 43 and 44. The spring device is designed to move vertically when force is applied and released. The two feet 43 and 44 and the top 41 can be conveniently used as anchoring points. The top bow spring 41 can be made relatively softer by using thinner sheet while the bottom bow spring sheets 42 can be made harder by using thicker sheet so that the complex spring has is pliable yet can still support a large force.

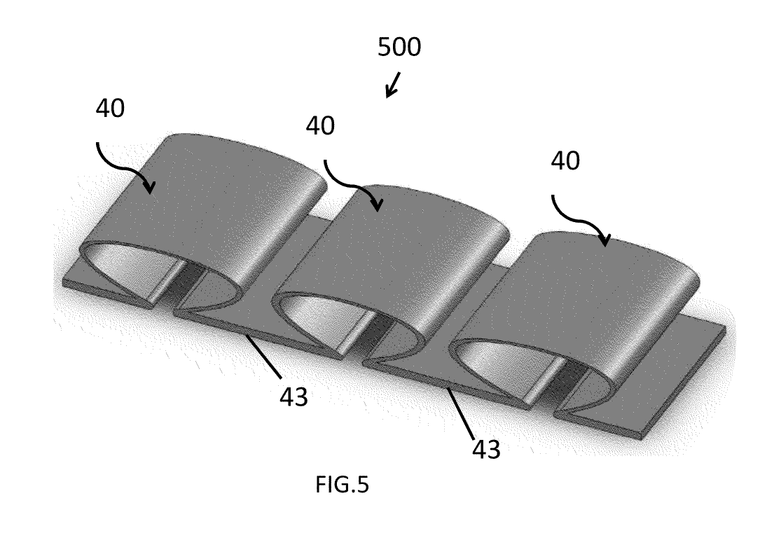

Many CFC springs can also be connected together to form a very large and flexible spring. Two example embodiments are disclosed. In reference in FIG. 5, three bow CFC springs 40 are connected near their feet in one direction to form a long belt device 500 in which surface portion 40s may serve as a point to apply force and feet 43 as anchoring points. This way the belt spring is flexible to fit in which each element response to local force. The belt spring 500 can be extended well beyond three elements to cover large areas, such as to fit inside a curved helmet, a contour seat or a large bed.

Another example spring 600 is shown in FIG. 6, three bow CF springs 60 having inwardly bended feet are connected via an anchor strip 61 near their top in one direction to form a spring 600 having some flexibility between. Spring 600 is well suited for shoe sole in which foot movement requires flexibility among each force damping spring elements.

The described spring designs offer many vanguard advantages. First, because of anisotropic construction using unidirectional carbon fiber and the thin sheet format, the spring configuration allows for maximum elastic deformation movement, thus a deformation capability of over 80% of its virgin height becomes achievable. Second, to take advantage of carbon fibers' extremely large tensile strength, the spring band-sheet is pre-curved along the carbon fibers strand direction. The spring configuration thus intrinsically provides exceptional counter forces to large loads. Third, due to the carbon fiber feature, it is extremely lightweight, lighter than polymer foam cushions of same overall thickness. Fourth, the sheet-band spring design allows efficient material use without generating much waste and can be fabricated from unidirectionally layered carbon fibers sheet without having to assort to the more expensive weaved cloth format. Fifth, the springs provide large kinetic energy absorption or storage and efficient energy recovery capabilities due to its large elastic displacement and force load. Sixth, by varying the bow shape and thickness, packing arrangement, the spring performance can be tailored according to various force level requirement and needs. Finally, it can be economically fabricated by composite molding, enabling wide consumer acceptable applications.

### Carbon Fiber Spring Making

Currently, carbon fiber composite parts of various shapes are made primarily with pre-preg materials or raw carbon fibers with resin infusions using vacuum bagging or autoclave processes. These processes have been decade old industry standards where vacuum pressure is essentially used to tightly hold the carbon fiber composite onto the mold and to enable uniform control of the epoxy soaking during the elevated temperature curing. They are complex, labor intense, time consuming, high capital requiring and materially wasteful, resulting in high cost for carbon fiber composite parts. These expensive processes have limited carbon fiber materials to the high end uses such as aerospace. Common consumers have not been able to afford the use of carbon fiber materials.

In order to allow carbon fiber springs be used to consumer products, a cost effective fabrication process and associated tooling is developed. This novel fabrication process facilitates low cost and high throughput production of carbon fiber composite components with little material waste.

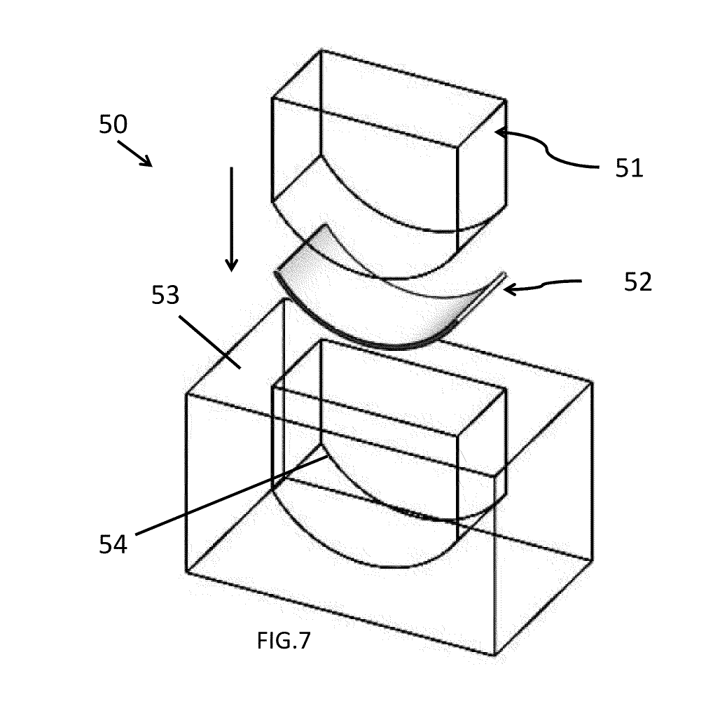

In references to FIG. 7, a two-piece bow shape mold 50 is shown, in which one is a hard mold 53 and another is a soft matching mold 51. The hard mold 53 can be made from a composite material replica of the sample or machined from drawings using wood or metal. The soft mold 51 is made of primarily silicone or other polymer rubber materials by pouring into the hard mold with wax sheet spacer before it is solidified.

As shown, to produce a carbon fiber composite spring 52, prepreg or resin soaked carbon fiber stows are placed into hard mold 53 with the carbon fibers laying along the curvature 54; then soft silicon matching mold 51 is fitted onto the carbon fiber composite sheet within hard mold 53 sandwiching the carbon fiber composite sheet in between, which is then followed by curing the sandwich at an elevated temperature. Because of the large thermal expansion ratio of silicone materials, soft mold 51 expands extensively during heating, providing two critical functions: carbon fiber sheet 52 is tightly pressed onto the contour of hard mold 53 while the excess resin in carbon fiber sheet 52 is squeezed out by the expansion of soft mold 51.

This new process eliminates the need for vacuum bagging or high pressure autoclaving, as well as wasting materials in molding. This process is especially designed for complex carbon fiber device fabrication, since the soft mold is naturally molding releasing and reusable. Therefore, the inventive rubber molding is advantageous for producing carbon fiber composite springs with low cost, fast processing time, and little material waste. In bow spring fabrication, it may be preferable to lay unidirectional carbon fiber stows along a bow curvature and cure with resin at an elevated temperature. This configuration fully utilizes the large tensile strength of carbon fiber to maximize the loading force and thus kinetic energy absorption capacity.

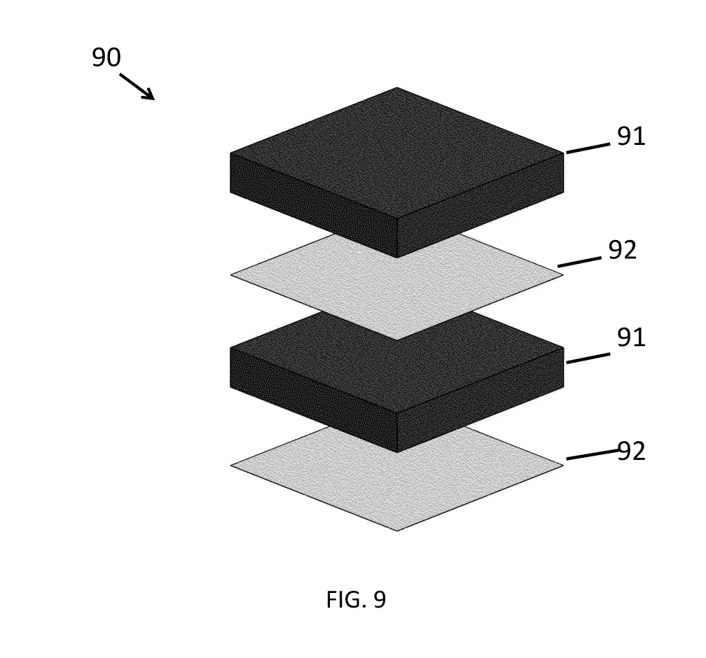

In reference to FIG. 9, alternatively, carbon fiber sheet is layered with an elastically deformable carbon fiber layer. Carbon fiber strands are first placed crossing each other with various degrees and then embedded with epoxy resin to form a layer 91. carbon fiber layers or sheets 91 are then bound with fabric layers 92 in a multilayer configuration. The hybrid sheet 90 is then molded into desired shape by the molding process described in FIG. 7. Many types of fabrics are found to be effective for layer 92, these fabrics at least include cotton, rayon, linen, synthetic clothes, fiber glass cloth, Kevlar cloth, wool, and leather. Other clothes made of different fibers can also be used. Different fabrics can result in different force load and bending dynamics.

To achieve maximal high strength potential, carbon fiber sheets 11 are preferably laid substantially uni-directionally in layering. Such hybrid flexible and elastic sheet of carbon fiber composites may be pressed into very thin sheets to be used for clothing, hat, and bags that require certain shape resistance strength.

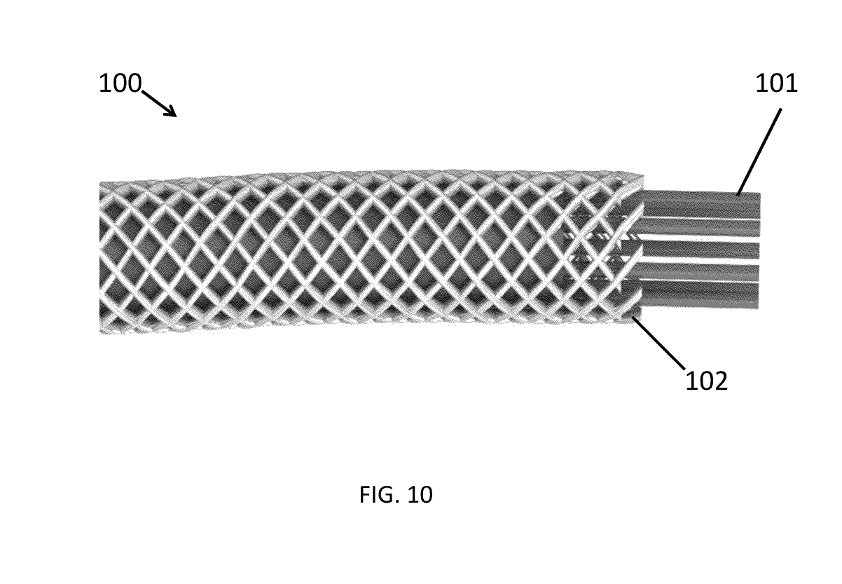

In reference to FIG. 10, alternatively, hybrid flexible carbon fiber composite 100 may be made similarly through the molding process described in FIG. 7 into threads by encapsulating a carbon fiber bundle 101 with cloth or braid of fabrics 102 in epoxy resin.

Using CFC springs in shoe sole can drastically increase its shock absorber level has not been attainable before. This is due to CFC spring's large compressible ratio, which can reach over 80%, while current performance shoes made of polymer foams have compressible ratio above 10%. Since energy absorption is approximately proportional to cushion's deformation, the shock absorption improvement of a CFC shoe can reach about 7 times that of the conventional foam shoes, sufficiently to reduce the impact forces for most athletic activities.

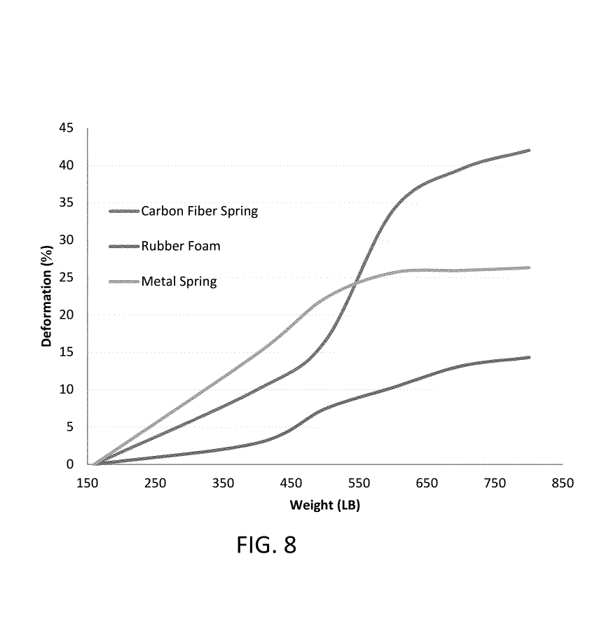

In reference to FIG. 8, a comparison of the elasticity between a prototype shoe sole containing CFC springs and a shoe sole containing rubber foams and a shoe sole containing metal coil springs. Under the same force, CFC shoe sole shows a much larger deformation ratio than a rubber foam shoe sole, about 3 times improvement. FIG. 8 also shows CFC spring shoe sole continues to deform thus damper at large force while meal spring shoe sole saturates due to short coil length. Moreover, in the test the CFC spring sole is four times lighter than metal spring sole, and two times lighter than the rubber foam sole.

Numerous characteristics and advantages of the invention have been set forth in the foregoing description, together with details of the structure and function of the invention, and the novel features hereof are pointed out in the appended claims. The disclosure, however, is illustrative only, and changes may be made in detail, especially in matters, shape, size, and arrangement of parts, within the principle of the invention, to the full extend indicated by the broad general meaning of the terms in which the appended claims are expressed.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

What is claimed:

1. A method for making a carbon-fiber composite sheet, comprising the steps of:
constructing a hard mold made of hard wood or plastic material having an interior shape, said hard mold's interior shape is carved in a designated shape to produce an sheet having said designated shape;
constructing a soft mold insert made of silicone or polymer rubber material having an exterior shape, said soft mold insert's exterior shape matching in shape with said hard mold's interior shape;
placing a carbon-fiber composite layer into the hard mold's interior shape wherein carbon-fiber filaments of the carbon-fiber composite layer are laid along said designated shape;
placing said soft-mold insert upon said carbon-fiber composite layer inside said hard mold's interior shape in such a way that a pressed-sandwich set is formed wherein said carbon-fiber composite layer is sandwiched between said hard mold and said soft mold insert;. heating said pressed-sandwich set at a temperature above 60° C.;
cooling said sandwich set; and
removing said soft mold and said hard mold.

2. The method of claim 1, wherein said soft mold is made by pouring liquid silicone or polymer rubber materials into said hard mold's interior shape with a wax sheet as spacer.

3. The method of claim 1, wherein said carbon-fiber composite layer comprises carbon-fiber filaments that are laid crossing with each other.

4. The method of claim 1, wherein the carbon-fiber filaments of carbon-fiber composite layer are laid in one same direction.

5. The method of claim 1, wherein the carbon-fiber filaments of said carbon-fiber composite layer are drenched with epoxy resin.

6. The method of claim 5, further comprising the step of:
placing a second layer of fabric member selected from cotton cloth, silk, linen cloth, synthetic polymer cloth, carbon fiber cloth, fiber glass cloth, Kevlar cloth, metal cloth, and leather, over said carbon-fiber composite layer before the step of placing said soft-mold insert.

7. The method of claim 6, wherein the carbon-fiber filaments of carbon-fiber composite layer are laid crossing with each other.

8. The method of claim 1, wherein the designated shape is an arched bow shape.

9. The method of claim 1, wherein the designated shape is an arched bow shape having bended supporting ends.
